(19) United States
(12) Patent Application Publication
(10) Pub. No.: US 2015/0033321 A1
(43) Pub. Date: Jan. 29, 2015

(54) CONSTRUCT LARGE-SCALE DVPN

(71) Applicant: Hangzhou H3C Technologies Co., Ltd., Hangzhou (CN)

(72) Inventors: Yinzhu Yang, Beijing (CN); Zhanqun Wang, Beijing (CN)

(21) Appl. No.: 14/372,724

(22) PCT Filed: Jan. 22, 2013
(86) PCT No.: PCT/CN2013/070820

§ 371 Date: Jul. 16, 2014

(30) Foreign Application Priority Data
Feb. 15, 2012 (CN) 201210033597.0

(51) Int. Cl. H04L 29/06; H04L 29/12

(52) U.S. Cl. CPC H04L 63/0272; H04L 61/20
USPC 726/12

(57) ABSTRACT

A Dynamic Virtual Private Network (DVPN) includes Virtual Private Network (VPN) Address Management (VAM) clients and a VAM server, and each VAM client includes a private gateway address, public address and subnet of the VAM client that are provided to the VAM server when registering in the VAM server. When a source VAM client receives a packet that is sent by a subnet of the source VAM client to a subnet of a destination VAM client, the source VAM client requests the VAM server to provide a next-hop address of subnet, a private gateway address, a public address and subnet of the destination VAM client to establish a DVPN tunnel between the source VAM client and the destination VAM client.

### BACKGROUND

More and more enterprises hope to construct a Virtual Private Network (VPN) through a public network. In many cases, branches of each enterprise access the public network through respective dynamic addresses. A Dynamic Virtual Private Network (DVPN) employing a VPN Address Management (VAM) protocol may be used to establish VPN tunnels if dynamic addresses are used.

### BRIEF DESCRIPTION OF THE DRAWINGS

Features of the present disclosure are illustrated by way of example and not limited in the following figure(s), in which like numerals indicate like elements, in which:

FIG. 1 is flowchart illustrating a method for constructing a large-scale DVPN according to an example of the present disclosure.

FIG. 2 is a schematic diagram illustrating a network structure with a Full-Mesh networking type according to an example of the present disclosure.

FIG. 3 is a schematic diagram illustrating a network structure with a Hub-Spoke networking type according to an example of the present disclosure.

FIG. 4 is a schematic diagram illustrating the structure of a client applied to a large-scale DVPN according to an example of the present disclosure.

FIG. 5 is a schematic diagram illustrating the hardware structure of a client according to an example of the present disclosure.

### DETAILED DESCRIPTION

In the conventional DVPN solution, the Hub needs to establish a routing neighbor relation with each Spoke, and thus needs to maintain a massive amount of routing neighbor information and other routing information in a large-scale network. In this way, system overhead is large, routing configuration is complex, and the network scale is limited by routing neighbor quantity and routing quantity in the dynamic routing protocol.

Hereinafter, the present disclosure is described in further detail with reference to the accompanying drawings and examples.

An example of the present disclosure provides a method for constructing a large-scale DVPN. The DVPN includes VAM clients and a VAM server. Each VAM client registers in the VAM server. The VAM client carries its private gateway address, public address and subnet when registering in the VAM server. The private gateway address is a Tunnel interface address, the public address is a Tunnel interface source address, and the subnet of each VAM client may be deployed in advance to avoid interference. The VAM server stores the private gateway address, public address and subnet carried by each VAM client when the VAM client registers in the VAM server.

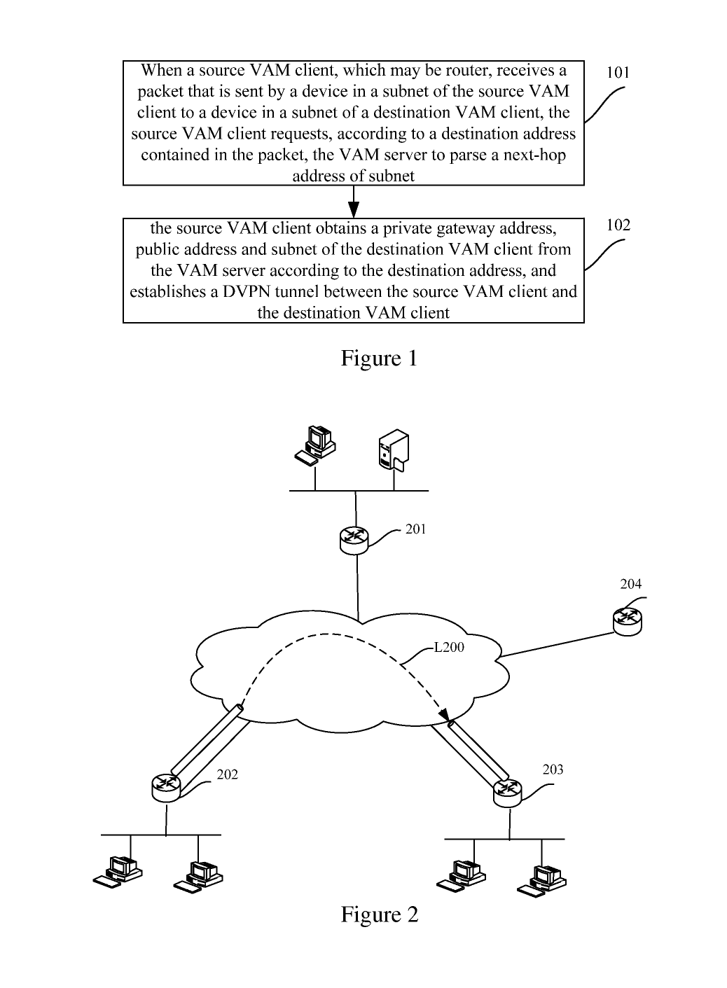

FIG. 1 is flowchart illustrating a method for constructing a large-scale DVPN according to an example of the present disclosure. The method includes the following processes.

At block 101, when a source VAM client, which may be a router, receives a packet that is sent by a device in the subnet of the source VAM client to a device in a subnet of a destination VAM client, the source VAM client requests, according to a destination address contained in the packet, the VAM server to parse a next-hop address of subnet, and then the VAM server returns a parsing result to the source VAM client. The next-hop address of subnet returned by the VAM server may be a private gateway address of the destination VAM client such as shown in the examples of Tables 1 and 2 below.

In this process, when the source VAM client receives the packet that is sent by the subnet of the source VAM client to the subnet of the destination VAM client, that is to say, when the source VAM client accesses the destination VAM client, the destination address contained in the packet is an address in the subnet segment of the destination VAM client.

At block 102, the source VAM client obtains a private gateway address, public address and subnet of the destination VAM client from the VAM server according to the destination address, and establishes a DVPN tunnel between the source VAM client and the destination VAM client.

In this process, the VAM server has a function of parsing the next-hop address of subnet. That is to say, the VAM server matches the destination address contained in the packet with subnets registered by other VAM clients. If the destination address is within the subnets registered by a certain VAM client, the VAM server issues the private gateway address, public address and subnet of the VAM client that requests the VAM server to parse the next-hop address of subnet.

In block 102, when the source VAM client obtains the private gateway address, public address and subnet of the destination VAM client from the VAM server according to the destination address, the source VAM client generates a static routing table item in a static routing table and an address mapping table item in an address mapping table. A destination address in the static routing table item is the subnet of the destination VAM client, and a next-hop address in the static routing table item is the private gateway address of the destination VAM client. A public address in the address mapping table item is the public address of the destination VAM client, and a next-hop address in the address mapping table item is the private gateway address of the destination VAM client. The static routing table may be maintained by a routing module or by the DVPN.

In block 101, after the source VAM client receives the packet that is sent by the subnet of the source VAM client to the subnet of the destination VAM client, and before the source VAM client requests, according to the destination address contained in the packet, the VAM server to parse the next-hop address of subnet, the method may further include that:

The source VAM client matches the destination address contained in the packet with the destination address in the static routing table; if a static routing table item in the static routing table matches the destination address contained in the packet, the source VAM client searches for, according to the next-hop address in the static routing table item, a DVPN tunnel corresponding to the next-hop address in the static routing table item, and forwards the packet through the DVPN tunnel.

The destination address in the static routing table item is the subnet of the destination VAM client. As long as the destination address contained in the packet is within the subnet, it is determined that the static routing table item matching the destination address contained in the packet is obtained.

If the static routing table item matching the destination address contained in the packet is obtained, but the DVPN tunnel corresponding to the next-hop address in the static routing table item is not obtained according to the next-hop address in the static routing table item, the source VAM client performs matching processing in the address mapping table according to the next-hop address in the static routing table item. If a public address corresponding to the next-hop address is obtained, the source VAM client establishes a DVPN tunnel according to the public address; otherwise, the source VAM client requests the VAM Server to parse the next-hop address, obtains the public address of the destination VAM client from the VAM server, stores the public address of the destination VAM client in the address mapping table, and establishes the DVPN tunnel according to the public address of the destination VAM client.

If the static routing table item matching the destination address contained in the packet is not obtained, the process of requesting, according to the destination address contained in the packet, the VAM server to parse the next-hop address of subnet and subsequent processes are performed.

If the static routing table item matching the destination address contained in the packet is not obtained, or the static routing table item matching the destination address contained in the packet is obtained but the DVPN tunnel corresponding to the next-hop address in the static routing table item is not obtained according to the next-hop address in the static routing table item, the source VAM client discards or does not process the received packet. The source VAM client determines, according to specific applications, to discard or not to process the received packet.

When establishing the DVPN tunnel between the source VAM client and other VAM clients, the source VAM client configures aging time for the DVPN tunnel. When generating the address mapping table item, the source VAM client configures aging time for the address mapping table item. The aging time configured for the DVPN and the aging time configured for the address mapping table item may be the same or different, and may be configured according to specific applications.

If the aging time configured for the DVPN tunnel expires, the source VAM client removes the DVPN tunnel, deletes the static routing table item corresponding to the DVPN tunnel. If the aging time configured for the address mapping table item expires, the source VAM client deletes the address mapping table item.

When receiving a notification of removing the DVPN tunnel that is sent by another VAM client, the source VAM client removes the DVPN tunnel that is established between the source VAM client and the VAM client sending the notification, and deletes the static routing table item and address mapping table item corresponding to the DVPN tunnel.

If the subnet of the source VAM client changes, the source VAM client notifies an opposite VAM client to remove the DVPN tunnel established between the source VAM client and the opposite VAM client and delete the static routing table item and address mapping table item corresponding to the DVPN tunnel. And then, the source VAM client deletes the local static routing table item and address mapping table item corresponding to the DVPN tunnel, removes the established DVPN tunnel, and registers in the VAM server again.

For two VAM clients between which the DVPN tunnel has been established, when the subnet of any VAM client changes, the VAM client notifies the opposite VAM client to remove the established DVPN tunnel and delete the static routing table item and address mapping table item corresponding to the DVPN tunnel. And then, the VAM client removes the established DVPN tunnel, deletes the local static routing table item and address mapping table item, and registers in the VAM server again. If the two VAM clients intend to communicate with each other, the process of parsing the next-hop address of subnet is performed again, and the DVPN tunnel is established again.

If the current networking type is Hub-Spoke and the source VAM client and the destination VAM client are both Spokes, when the source VAM client requests, according to the destination address, the VAM server to parse the next-hop address of subnet, the source VAM client obtains the private gateway address and public address of the Hub and the subnet of the destination VAM client, establishes the DVPN tunnel between source VAM client and the Hub, and generates the static routing tab e item and the address mapping table item.

The VAM server may configure the current networking type as Hub-Spoke or Full-Mesh. When the source VAM client requests the VAM server to parse the next-hop address of subnet, the VAM server determines a result to be issued according to the current networking type. For example, if the current networking type is Hub-Spoke, the VAM server may issue different Hub information to different Spokes, so as to implement load sharing.

A process of establishing a dynamic DVPN tunnel between VAM clients in different types of networks is illustrated in detail hereinafter with reference to the accompanying drawings and specific examples.

FIG. 2 is a schematic diagram illustrating a network structure with a Full-Mesh networking type according to an example of the present disclosure. The network shown in FIG. 2 includes a Hub201, a Spoke202, a Spoke203 and a VAM server 204. A DVPN tunnel is established between the Spokes and the Hub. The process of establishing the DVPN tunnel between the Spokes and the Hub is similar to the process of establishing the DVPN tunnel between the Spokes. The process of establishing a dynamic DVPN tunnel between the Spoke202 and the Spoke203 is illustrated in detail hereinafter with reference to an example that the Spoke202 forwards data to the Spoke203.

Suppose the private gateway address of the Hub201 is 10.1.1.1, the public address of the Hub201 is 202.1.1.11 and the subnet of the Hub201 is 192.168.1.0/24. Suppose the private gateway address of the Spoke202 is 10.1.1.2, the public address of the Spoke202 is 202.1.1.12, and subnet of the Spoke202 is 192.168.2.0/24. Suppose the private gateway address of the Spoke203 is 10.1.1.3, the public address of the Spoke203 is 202.1.1.13, and subnet of the Spoke203 is 192.168.3.0/24. When registering in the VAM server 204, the Hub201, the Spoke202 and the Spoke203 carry respective private gateway addresses, public addresses and subnets.

When receiving a packet that is sent by a subnet device of the Spoke202 to a subnet device of the Spoke203, where the destination address contained in the packet is 192.168.3.4, the Spoke202 requests, according to the destination address, the VAM server 204 to parse the next-hop address of subnet, and receives the private gateway address, public address and subnet of the Spoke203 that are obtained by the VAM server 204 according to the destination address.

The Spoke202 creates a static routing table item in a static routing table and an address mapping table item in an address mapping table according to the address information of the Spoke203, and establishes a dynamic DVPN tunnel between the Spoke202 and the Spoke203 through interacting with the Spoke203. L200 shown in FIG. 2 is the established DVPN tunnel. Table 1 is a static routing table created in the network with the Full-Mesh networking type. The destination address in Table 1 is the subnet of the Spoke203, and the next-hop address is the private gateway address of the Spoke203. Table 2 is an address mapping table created in the network with the Full-Mesh networking type. The next-hop address in Table 2 is the private gateway address of the Spoke203, and the public address is the public address of the Spoke203.

TABLE 1

| destination address | next-hop address |
|---|---|
| 192.168.3.0/24 | 10.1.1.3 |

TABLE 2

| public address | next-hop address |
|---|---|
| 202.1.1.13 | 10.1.1.3 |

When receiving a packet that is sent by the subnet device of the Spoke202 to the subnet device of the Spoke203 again, the Spoke202 obtains the DVPN tunnel corresponding to the next-hop address in the static routing table item according to the next-hop address in the static routing table item, and forwards the packet through the DVPN tunnel.

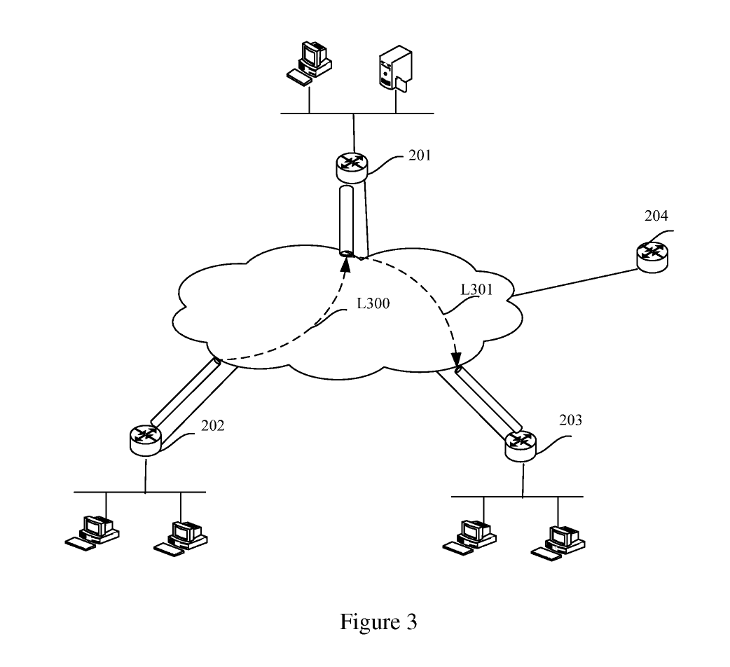

FIG. 3 is a schematic diagram illustrating a network structure with a Hub-Spoke networking type according to an example of the present disclosure. The clients and server in FIG. 3 are the same as those shown in FIG. 2, and the address and registering procedure of each device are the same as those shown in FIG. 2. In the network with the Hub-Spoke networking type, the procedure of establishing the DVPN tunnel between the Spoke and the Hub is identical to the procedure of establishing the DVPN tunnel between the Spoke and the Hub in the network with the Full-Mesh networking type, but the procedure of establishing the DVPN tunnel between the Spoke and the Spoke is different from the procedure of establishing the DVPN tunnel between the Spoke and the Spoke in the network with the Full-Mesh networking type. The procedure of establishing the DVPN tunnel between the Spoke and the Spoke in the network with the Hub-Spoke networking type is illustrated in detail hereinafter.

In FIG. 3, when receiving a packet that is sent by the subnet device of the Spoke202 to the subnet device of the Spoke203, where the destination address contained in the packet is 192.168.3.4, the Spoke202 requests, according to the destination address, the VAM server 204 to parse the next-hop address of subnet, and receives the private gateway address and public address of the Hub201 and the subnet of the Spoke203 from the VAM server 204 according to the destination address. In this example, the VAM server 204 designates the Hub201 to forward the packet. In an actual large-scale network, the VAM server designates, according to specific configuration, a Hub for forwarding the packet.

The Spoke202 creates the static routing table item and address mapping table item according to the obtained address information of the Hub201 and the subnet of the Spoke203, and establishes a dynamic DVPN tunnel between the Spoke202 and the Hub201 through interacting with the Hub201. L300 in FIG. 3 is the DVPN tunnel established between the Spoke202 and the Hub201. Table 3 is a static routing table created in the network with the Hub-Spoke networking type. The destination address in Table 3 is the subnet of the Spoke203, and the next-hop address is the subnet gateway address of the Hub201. Table 4 is an address mapping table created in the network with the Hub-Spoke networking type. The next-hop address in Table 4 is the subnet gateway address of the Hub201 and the public address is the public address of the Hub201.

TABLE 3

| destination address | next-hop address |
|---|---|
| 192.168.3.0/24 | 10.1.1.1 |

TABLE 4

| public address | next-hop address |
|---|---|
| 202.1.1.11 | 10.1.1.1 |

When receiving a packet that is sent by the subnet device of the Spoke202 to the subnet device of the Spoke203 again, the Spoke202 obtains the DVPN tunnel corresponding to the next-hop address in the static routing table item according to the next-hop address in the static routing table item, and forwards the packet through the DVPN tunnel.

When receiving the packet that is sent by the Spoke202 to the Spoke203, the Hub201 requests the VAM server 204 to parse the next-hop address of subnet, and establishes the DVPN tunnel between the Hub201 and the Spoke203, for example, the DVPN tunnel L301 in FIG. 3. The procedure of establishing the DVPN tunnel is identical to that described in FIG. 2, and is not illustrated in detail. It can be seen from FIG. 3 that the communication between Spokes is implemented through the Hub in the network with the Hub-Spoke networking type.

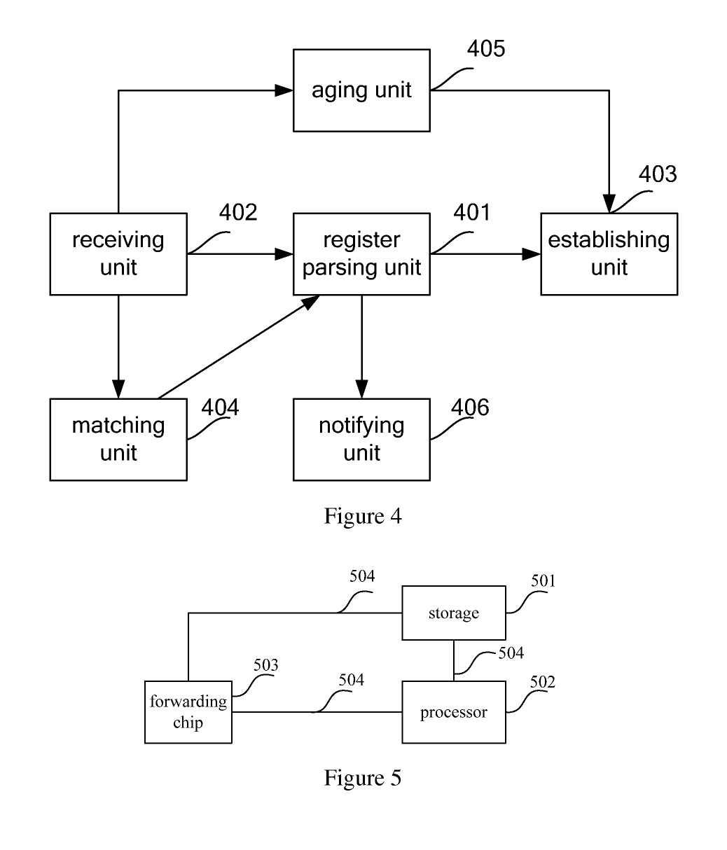

Based on the same idea, an example of the present disclosure provides a client, which may be applied to a large-scale DVPN, referring to FIG. 4. FIG. 4 is a schematic diagram illustrating the structure of a client applied to a large-scale DVPN according to an example of the present disclosure. The client includes a register parsing unit 401, a receiving unit 402 and an establishing unit 403.

The receiving unit 402 is to receive a packet that is sent by a subnet of the client where the receiving unit 402 is located to a subnet of a destination VAM client.

The register parsing unit 401 is to register in a VAM server, and carry a private gateway address, public address and subnet of the client where the register parsing unit 401 is located when registering in the VAM server; request, according to a destination address contained in the packet received by the receiving unit 402, the VAM server to parse a next-hop address of subnet, obtain a private gateway address, public address and subnet of the destination VAM client from the VAM server according to the destination address.

The establishing unit 403 is to establish a DVPN tunnel between the client and the destination VAM client according to the private gateway address, public address and subnet of the destination VAM client that are obtained by the register parsing unit 401.

The establishing unit 403 is further to generate a static routing table item in a static routing table and an address mapping table item in an address mapping table, where a destination address in the static routing table item is the subnet of the destination VAM client, and a next-hop address in the static routing table item is the private gateway address of the destination VAM client. A public addresses in the address mapping table item is the public addresses of the destination VAM client, and a next-hop address in the address mapping table item is the private gateway address of the destination VAM client.

The client further includes a matching unit 404.

The matching unit 404 is to match the destination address contained in the packet received by the receiving unit 402 with the destination address in the static routing table item generated by the establishing unit 403; if a static routing table item in the static routing table matches the destination address contained in the packet, and a DVPN tunnel corresponding to a next-hop address in the static routing table item is obtained according to the next-hop address in the static routing table item, forward the packet through the DVPN tunnel; if the static routing item matching the destination address contained in the packet is obtained, but the DVPN tunnel corresponding to the next-hop address in the static routing table item is not obtained according to the next-hop address in the static routing table item, perform matching processing in the address mapping table according to the next-hop address in the static routing table item; if a public address corresponding to the next-hop address is obtained, establish the DVPN tunnel according to the public address; otherwise, request the VAM server to parse the next-hop address, obtain the public address of the destination VAM client from the VAM server, store the public address of the destination VAM client in the address mapping table, and establish the DVPN tunnel according to the obtained public address of the destination VAM client; if the static routing table item matching the destination address contained in the packet is not obtained, trigger the register parsing unit 401 to perform the process of requesting, according to the destination address contained in the packet, the VAM server to parse the next-hop address of subnet.

The client further includes an aging unit 405.

The aging unit 405 is to determine aging time for the established DVPN tunnel, and determine aging time for the address mapping table item; remove the DVPN tunnel when the aging time configured for the DVPN tunnel expires, and delete the static routing table item corresponding to the DVPN tunnel; delete the address mapping table item when the aging time configured for the address mapping table item expires. The aging times may be set by a user or a system and stored and retrieved as needed.

The receiving unit 402 is to receive a notification of removing the DVPN tunnel sent by another VAM client.

The establishing unit 403 is further to, when the receiving unit 402 receives the notification of removing the DVPN tunnel sent by another VAM client, remove the DVPN tunnel established between the client and the VAM client sending the notification, and delete the static routing table item and address mapping table item corresponding to the DVPN tunnel.

The client further includes a notifying unit 406.

The register parsing unit 401 is to, when the subnet of the client where the register parsing unit 401 is located changes, delete the local static routing table item and address mapping table item, and register in the VAM server again.

The notifying unit 406 is to, when the subnet of the client where the notifying unit 406 is located changes, notify an opposite VAM client to remove the DVPN tunnel established between the client and the opposite VAM client.

The register parsing unit 401 is to, if the current networking type is Hub-Spoke, and the client where register parsing unit 401 is located and the destination VAM client are both Spokes, request, according to the destination address contained in the packet, the VAM server to parse the next-hop address of subnet, and obtain the private gateway address and public address of a Hub and the subnet of the destination VAM client from the VAM server according to the destination address.

The establishing unit 403 is to establish the DVPN tunnel between the client and the Hub according to the private gateway address and public address of the Hub and the subnet of the destination VAM client that are obtained by the register parsing unit 401, and generate the static routing table item and the address mapping table item.

The modules or units in the above examples may be integrated into one body, or may be deployed separately; may be merged into one module or unit, or may be divided into multiple sub-modules or sub-units furthermore.

The modules or units in the above examples may be implemented in a mechanical mode or an electrical mode. For example, one hardware module may include a special permanent circuit or logic appliance (e.g., a special processor such as FPGA or ASIC) for implementing specific operations. The hardware module may include programmable logic appliance or circuit configured temporarily by software to execute specific operations, e.g., include a general processor or other programmable processors. It may be determined according to time and cost whether the mechanical mode, the special permanent circuit or the circuit configured temporarily (configured by software) is adopted.

The client is described according to the examples in the above, and the hardware structure of the client is illustrated hereinafter according to an example. The client may be a programmable device implemented with hardware and software comprised of machine readable instructions, referring to FIG. 5. FIG. 5 is a schematic diagram illustrating the hardware structure of a client according to an example of the present disclosure. The client includes a storage 501, a processor 502, a forwarding chip 503, and an interconnection structure 504 coupling the storage 501, the processor 502 and the forwarding chip 503.

The storage 501 is to store instruction codes. When the instruction codes are executed, implemented operations include the functions implemented by the register parsing unit, the receiving unit and the establishing unit of the client, which is not illustrated in detail herein.

The processor 502 is to communicate with the forwarding chip 503 to receive and send packets; communicate with the storage 501 to read and execute the instruction codes stored in the storage 501, implement the functions implemented by the register parsing unit, the receiving unit and the establishing unit.

The forwarding chip 503 is to perform forwarding processing for the packets, and receive and send the packets from and to the processor 502.

It should be noted that, the client shown in FIG. 5 is only an example, which may have another structure different from that described by the example. For example, the operations implemented by the above instruction codes may be implemented by a specific an Application Specific Integrated Circuit (ASIC) or a Network Processor (NP). In addition, there may be one or more above processors 502. If there are multiple processors, the processors read and execute the instruction codes together. The structure of the client is not limited in this disclosure.

To sum up, each VAM client of the present disclosure carries its private gateway address, public address and subnet when registering in the VAM server. When intending to access the destination VAM client, the source VAM client requests the VAM server to parse the next-hop address of subnet, obtains the private gateway address, public address and subnet of the destination VAM client, and further establishes the dynamic DVPN tunnel to forward the packet. Through the above method, a permanent tunnel does not need to be established between the Spoke and the Hub, so that the DVPN tunnel does not depend on the dynamic routing protocol any more. In this way, the flexibility of constructing the DVPN is increased, and the system overhead and routing configuration of the Hub is decreased in the large-scale network. The DVPN tunnel established between the VAM clients is dynamic, and may be removed automatically when the aging time configured for the DVPN tunnel expires.

When the networking type is Hub-Spoke, the VAM server may issue different Hub information to different Spokes, so as to implement load sharing.

For the VAM clients between which the DVPN tunnel has been established, when the subnet of any VAM client changes, the VAM client registers again, and notifies an opposite VAM client to remove the established DVPN tunnel, and deletes the static routing table item and address mapping table item corresponding to the DVPN tunnel. In this way, the routing shock of the whole network that is caused because the subnet of one VAM client changes may be avoided.

The foregoing describes some examples and is not used to limit the protection scope of this disclosure. Any modification, equivalent substitution and improvement without departing from the spirit and principle of this disclosure are within the protection scope of this disclosure.

What is claimed is:

1. A method for constructing a large-scale Dynamic Virtual Private Network (DVPN), wherein the DVPN comprises Virtual Private Network (VPN) Address Management (VAM) clients and a VAM server, and each VAM client includes a private gateway address, public address and subnet of the VAM client provided to the VAM server when registering in the VAM server, the method comprising:
when a source VAM client receives a packet that is sent by a subnet of the source VAM client to a subnet of a destination VAM client, requesting, by the source VAM client according to a destination address contained in the packet, the VAM server to parse a next-hop address of subnet, obtaining a private gateway address, public address and subnet of the destination VAM client that are sent by the VAM server according to the destination address, and establishing a DVPN tunnel between the source VAM client and the destination VAM client.

2. The method of claim 1, when the source VAM client obtains the private gateway address, public address and subnet of the destination VAM client, the method further comprises:
generating a static routing table item in a static routing table and an address mapping table item in an address mapping table, wherein a destination address in the static routing table item is the subnet of the destination VAM client, a next-hop address in the static routing table item is the private gateway address of the destination VAM client, a public address in the address mapping table item is the public address of the destination VAM client, and a next-hop address in the address mapping table item is the private gateway address of the destination VAM client.

3. The method of claim 2, after the source VAM client receives the packet that is sent by the subnet of the source VAM client to the subnet of the destination VAM client, and before the source VAM client requests, according to the destination address contained in the packet, the VAM server to parse the next-hop address of subnet, the method further comprises:
matching the destination address contained in the packet with the destination address in the static routing table;
if a static routing table item in the static routing table matches the destination address contained in the packet, and a DVPN tunnel corresponding to a next-hop address in the static routing table item is obtained, forwarding the packet through the DVPN tunnel;
if the static routing table item matching the destination address contained in the packet is obtained, and the DVPN tunnel corresponding to the next-hop address in the static routing table item is not obtained, performing matching processing in the address mapping table according to the next-hop address in the static routing table item;
if a public address corresponding to the next-hop address is obtained, establishing a DVPN tunnel according to the public address in the address mapping table item; otherwise, requesting the VAM server to parse the next-hop address of subnet, obtaining the public address of the destination VAM client from the VAM server, storing the public address of the destination VAM client in the address mapping table, and establishing the DVPN tunnel according to the public address of the destination VAM client; and
if the static routing table item matching the destination address contained in the packet is not obtained, performing the process of requesting the VAM server to parse the next-hop address of subnet and subsequent processes.

4. The method of claim 2, when the DVPN tunnel is established, the method further comprises:
determining, by the source VAM client, aging time for the established DVPN tunnel, and determining aging time for the address mapping table item;
when the aging time for the DVPN tunnel expires, removing the DVPN tunnel and deleting the static routing table item corresponding to the DVPN tunnel, and, when the aging time for the address mapping table item expires, deleting the address mapping table item; and
when receiving a notification of removing the DVPN tunnel that is sent by the destination VAM client, removing the DVPN tunnel that is established between the source VAM client and the destination VAM client, and deleting the static routing table item and address mapping table item corresponding to the DVPN tunnel.

5. The method of claim 2, further comprising:
if the subnet of the source VAM client changes, notifying an opposite VAM client to remove the DVPN tunnel that is established between the source VAM client and the opposite VAM client, deleting the local static routing table item and address mapping table item, removing the established DVPN tunnel, and registering in the VAM server again.

6. A method for constructing a large-scale Dynamic Virtual Private Network (DVPN), wherein the DVPN comprises Virtual Private Network (VPN) Address Management (VAM) clients and a VAM server, each VAM client includes a private gateway address, public address and subnet of the VAM client provided to the VAM server when registering in the VAM server, and if a current networking type is Hub-Spoke, and a source VAM client and a destination VAM client are both Spokes, the method comprises:
when the source VAM client receives a packet that is sent by a subnet of the source VAM client to a subnet of the destination VAM client, requesting, by the source VAM client according to a destination address contained in the packet, the VAM server to parse a next-hop address of subnet, obtaining a private gateway address and public address of a Hub and a subnet of the destination VAM client that are sent by the VAM server according to the destination address, and establishing a DVPN tunnel between the source VAM client and the Hub.

7. The method of claim 6, when the source VAM client obtains the private gateway address and public address of the Hub and the subnet of the destination VAM client, the method further comprises:
generating a static routing table item in a static routing table and an address mapping table item in an address mapping table, wherein a destination address in the static routing table item is the subnet of the destination VAM client, a next-hop address in the static routing table item is the private gateway address of the Hub, a next-hop address in the address mapping table item is the private gateway address of the Hub, and a public address in the address mapping table item is the public address of the Hub.

8. A client, applied to a large-scale Dynamic Virtual Private Network (DVPN) that comprises Virtual Private Network (VPN) Address Management (VAM) clients and a VAM server, comprising a register parsing unit, a receiving unit and an establishing unit; wherein
the receiving unit is to receive a packet that is sent by a subnet of the client to a subnet of a destination VAM client;
the register parsing unit is to register in the VAM server a private gateway address, public address and subnet of the client when registering in the VAM server; request, according to a destination address contained in the packet received by the receiving unit, the VAM server to parse a next-hop address of subnet, obtain a private gateway address, public address and subnet of the destination VAM client that are sent by the VAM server according to the destination address; and
the establishing unit is to establish a DVPN tunnel between the client and the destination VAM client according to the private gateway address, public address and subnet of the destination VAM client that are obtained by the register parsing unit.

9. The client of claim 8, wherein
the establishing unit is further to generate a static routing table item in a static routing table and an address mapping table item in an address mapping table, wherein a destination address in the static routing table item is the subnet of the destination VAM client, a next-hop address in the static routing table item is the private gateway address of the destination VAM client, a public address in the address mapping table item is the public address of the destination VAM client, and a next-hop address in the address mapping table item is the private gateway address of the destination VAM client.

10. The client of claim 9, further comprising:
a matching unit, to match the destination address contained in the packet received by the receiving unit with the destination address in the static routing table item; if a static routing table item in the static routing table matches the destination address contained in the packet, and a DVPN tunnel corresponding to a next-hop address in the static routing table item is obtained, forward the packet through the DVPN tunnel;
if the static routing table item matching the destination address contained in the packet is obtained, but the DVPN tunnel corresponding to the next-hop address in the static routing table item is not obtained, perform matching processing in the address mapping table according to the next-hop address in the static routing table item; if a public address corresponding to the next-hop address is obtained, establish a DVPN tunnel according to the public address; otherwise, request the VAM server to parse the next-hop address of subnet, obtain the public address of the destination VAM client from the VAM server, store the public address of the destination VAM client in the address mapping table, and establish the DVPN tunnel according to the public address of the destination VAM client; if the static routing table item matching the destination address contained in the packet is not obtained, perform the process of requesting the VAM server to parse the next-hop address of subnet and subsequent processes.

11. The client of claim 9, further comprising:
an aging unit, to determine aging time for the established DVPN tunnel, and determine aging time for the address mapping table item; remove the DVPN tunnel when the aging time for the DVPN tunnel expires, delete the static routing table item corresponding to the DVPN tunnel; and delete the address mapping table item when the aging time for the address mapping table item expires; wherein
the receiving unit is further to receive a notification of removing the DVPN tunnel that is sent by an opposite VAM client; and
the establishing unit is to, when the receiving unit receives the notification of removing the DVPN tunnel that is sent by the opposite VAM client, remove the DVPN tunnel that is established between the client and the opposite VAM client sending the notification, and delete the static routing table item and address mapping table item corresponding to the DVPN tunnel.

12. The client of claim 9, further comprising a notifying unit; wherein
the register parsing unit is to, if the subnet of the client where the register parsing unit is located changes, delete the local static routing table item and address mapping table item, and register in the VAM server again;
the notifying unit is to, when the subnet of the client where the notifying unit is located changes, notify an opposite VAM client to remove the DVPN tunnel that is established between the client and the opposite VAM client.

13. A client, applied to a large-scale Dynamic Virtual Private Network (DVPN) that comprises Virtual Private Network (VPN) Address Management (VAM) clients and a VAM server, a current networking type is Hub-Spoke, and the client and a destination VAM client are both Spokes, the client comprising a register parsing unit, a receiving unit and an establishing unit; wherein
the receiving unit is to receive a packet that is sent by a subnet of the client to a subnet of a destination VAM client;
the register parsing unit is to register in the VAM server, and carry a private gateway address, public address and subnet of the client when registering in the VAM server; request, according to a destination address contained in the packet received by the receiving unit, the VAM server to parse a next-hop address of subnet, obtain a private gateway address and public address of a Hub and a subnet of the destination VAM client that are sent by the VAM server according to the destination address; and
the establishing unit is to establish a DVPN tunnel between the client and the Hub according to the private gateway address and public address of the Hub and the subnet of the destination VAM client that are obtained by the register parsing unit.

14. The client of claim 13, wherein
the establishing unit is further to generate a static routing table item in a static routing table and an address mapping table item in an address mapping table, wherein a destination address in the static routing table item is the subnet of the destination VAM client, a next-hop address in the static routing table item is the private gateway address of the Hub, a next-hop address in the address mapping table item is the private gateway address of the Hub, and a public address in the address mapping table item is the public address of the Hub.
